(19) United States
(12) Patent Application Publication
(10) Pub. No.: US 2003/0142586 A1
(43) Pub. Date: Jul. 31, 2003

(54) Smart self-calibrating acoustic telemetry system

(76) Inventors: Vimal V. Shah, Houston, TX (US); Donald G. Kyle, Plano, TX (US); Wallace R. Gardner, Houston, TX (US)

Correspondence Address: CARSTENS YEE & CAHOON, LLP, P O BOX 802334, DALLAS, TX, 75380

(21) Appl. No.: 10/059,782

(22) Filed: Jan. 30, 2002

(51) Int. Cl. H04H 9/00; G01V 3/00

(52) U.S. Cl. 367/82; 340/853.7; 340/853.2

(57) ABSTRACT

An acoustic telemetry system for use in a borehole achieves both bi-directional and multi-hop communications without need for a wireline. Each step in the communications link comprises a processor and transceiver, which communicate with adjacent transceivers to achieve self-optimization. During operation, if communications deteriorate, each pair of transceivers can re-initiate optimization and attempt to reset parameters to achieve improved communications. Similarly, the system can also re-calibrate periodically to assure that optimal conditions are maintained.

### TECHNICAL FIELD

The present invention relates to acoustic telemetry in a downhole situation. More specifically, it relates to improved communications between downhole telemetry units, including self-calibration between units, to reduce the time and effort necessary for previous calibration methods.

### BACKGROUND OF THE INVENTION

In the field of oil and gas drilling, it has long been desirable to receive information from inside a borehole that may extend a mile or further below the surface. Various methods have been tried for transmitting and receiving this type of information, including electromagnetic radiation through the ground formation, electrical transmission through an insulated conductor, pressure pulse propagation through the drilling mud, and acoustic wave propagation through the metal drillstring. The assignee of this application has previously developed a method of using acoustic wave propagation through the pipe in conjunction with drill stem testing (DST) tools, although this system is also applicable in other situations, such as communications during drilling and during production.

FIG. 1A is an overview of a land based DST rig using the older version of the acoustic telemetry system. At the surface, the rig 100 is seen, with a top transceiver 110 clamped onto the tubing just above the rotary table on the rig floor to receive data from the down-hole equipment and transmit the data to a data processing unit that is located at a remote site. Several sections of tubing for the test rig are seen, including a section having a repeater 120 and a section having sensors and a transmitter 130. The rig of FIG. 1A is also suitable for offshore jack-up rigs. FIG. 1B is an overview of a floating test rig 100′ located offshore. The top transceiver 110′ in this embodiment is not placed at the surface of the water, as subsea safety systems severely attenuate or prevent the acoustic signals from passing through. Instead, the transceiver electronics have been integrated into the linkage unit 140 located close to the subsea wellhead.

FIGS. 2A and 2B show respective sections of the tubing used in this prior art system. This tubing is threaded, 5¼ inch outside diameter, with a 2¼ inch inside diameter. All the necessary components for sensing and transmitting information are built into the walls of the tubing, as seen in the partial section on the right side of each figure. The section 200, shown in FIG. 2A, includes pressure/temperature sensors 210, electronics 220, batteries 230, and an acoustic stack 240. FIG. 2B shows another section of tubing 250, which has no sensors, but has the electronics 220, batteries 230, acoustic stack 240. This section acts as a transceiver (receiver and transmitter) in order to forward signals from downhole. The maximum depth at which reliable signals from the downhole transceiver can be received is about 6000 feet. At greater distances, section 250 is used as a repeater, to extend the depth from which signals can be received to approximately 12,000 feet. With the above equipment, once calibration has been performed, communications are bi-directional; that is, not only is information sent to the surface, commands can also be sent downhole.

Work has been done in predicting the optimal frequencies for data transmission on downhole pipe or tubing, such as calculating pass bands and stop bands for particular configurations. One of the problems faced by this type of system is that many variables, such as workstring configuration, deviation, mud weight, etc., affect the transmissions on any given frequency differently, so that calibration of communications between the components cannot be done prior to their use. This calibration has previously been done by use of electronics encased in a probe on a wireline. In the drill stem testing above, the probe is lowered when the tubing components for the Acoustic Telemetry System (ATS) are in place; the probe communicates with the downhole components to determine the best frequencies on which to operate for optimal performance. After the frequency is reset for each component, the probe is removed and drill stem testing commences. Changes to any of the transmission parameters require stopping testing, reinserting the probe, and recalibrating. A better method of calibration for this application and related applications is desirable.

### SUMMARY OF THE INVENTION

In the innovative acoustic telemetry system, each section that contains components includes sensors, a transceiver (which both receives and transmits), a processor, and a power source. The processor is capable of analyzing a signal and determining both the optimal frequency or frequencies for communications and the optimal method of communications. Improvements to the existing telemetry system revolve around three new capabilities:

1) The innovative acoustic telemetry system is fully bi-directional and multi-hop from the beginning. Unlike the prior system, this innovative acoustic telemetry system has techniques by which initial communications can be self-established between the various transceivers, without the need for a wireline probe. This is important in terms of the next two improvements.

2) The system is self-optimizing. Each transceiver communicates with the transceivers nearest it. Through the initial contact, each pair establishes the best communications channel or channels in which to operate and determines the optimal communications scheme for the available channels.

3) The system is self-adapting to changing conditions. The system does not simply continue to use the same parameters when conditions change. If communications deteriorate, the pairs of transceivers will re-initiate the optimization step and attempt to reset to better channels. The system can also re-calibrate periodically to assure that optimal conditions are maintained.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIGS. 1A and 1B show overviews of a prior art land-based rig and an offshore drill rig with drill stem test equipment and a prior art communication system.

FIG. 2A shows a prior art section of tubing for drill string testing having downhole sensors and a transmitter, while 2B shows a prior art section with a transceiver but no sensors.

FIGS. 3A and 3B show a diagrammatic representation of different embodiments of a drill string containing the disclosed downhole communication system.

FIGS. 4A and 4B demonstrate alternative flowcharts for activating the system of the present disclosure, using bottom-upward and top-downward directions of calibration respectively.

FIG. 5 shows a flowchart of the steps of calibrating one transceiver with an adjacent transceiver in accordance with a preferred embodiment of the disclosed invention.

FIGS. 6A-6F demonstrate a tone burst at the transmitter and the signal received at the receiver for three different tone burst cycles in accordance with a preferred embodiment of the disclosed invention.

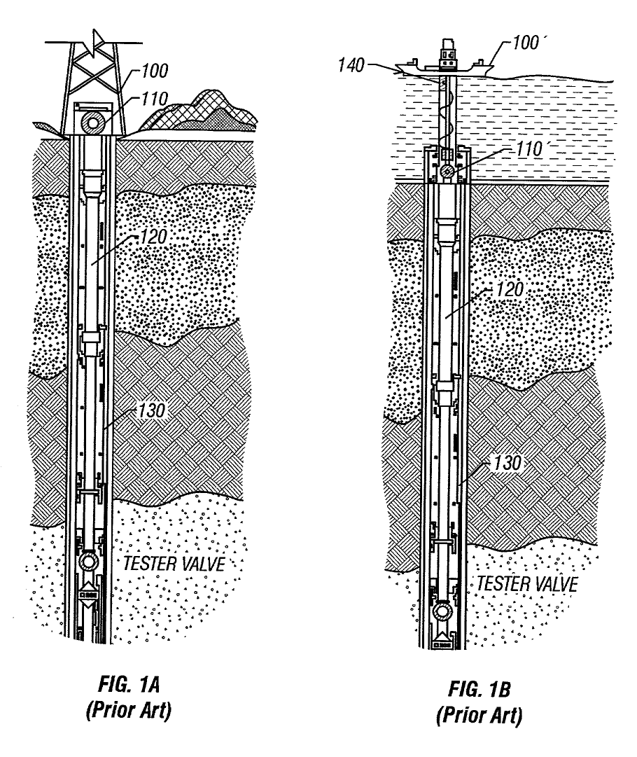

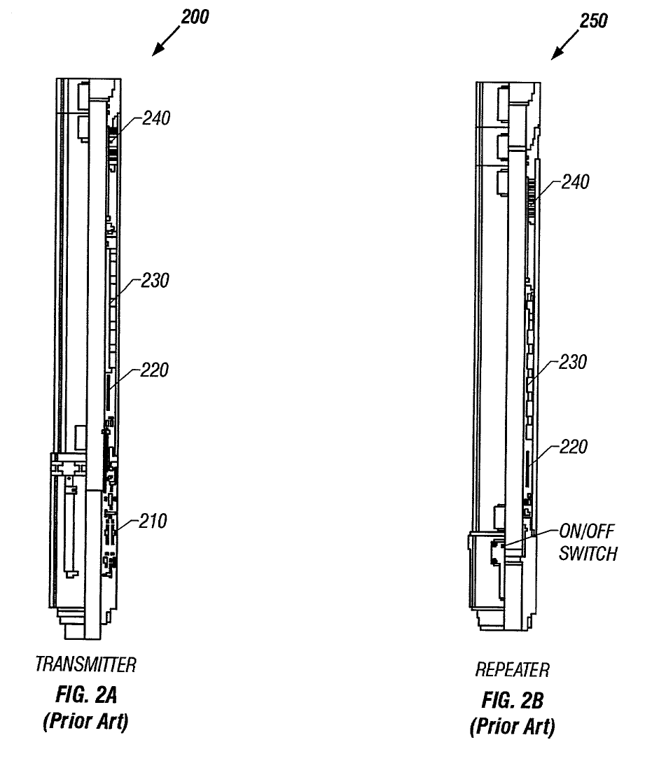

### DETAILED DESCRIPTION OF THE DRAWINGS

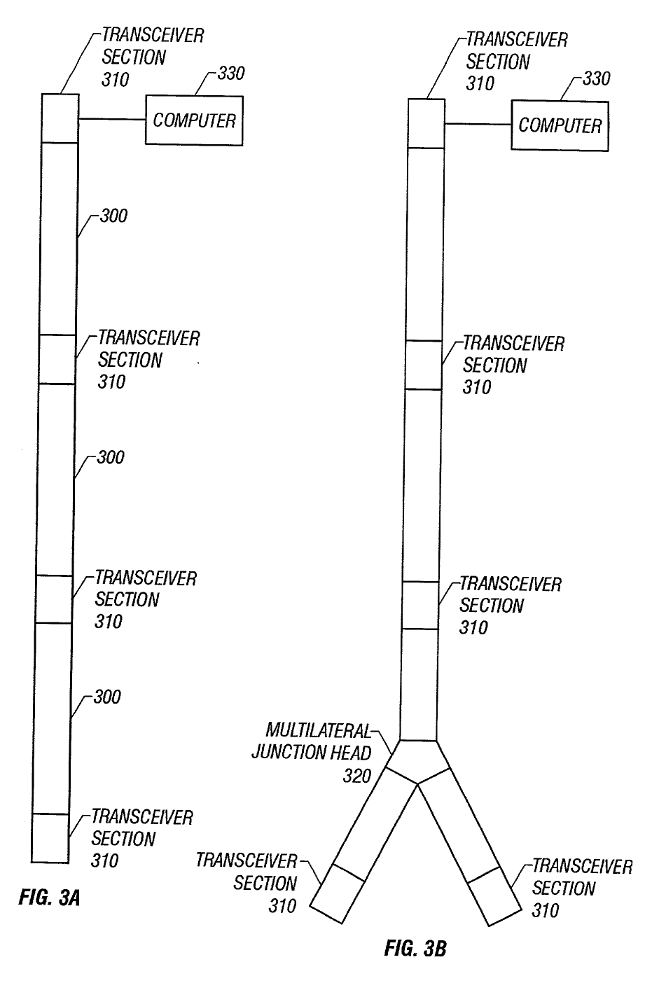

An embodiment of the disclosed communication system will now be discussed in further detail. FIG. 3A gives an overall schematic view of one embodiment of the communications system. At the borehole, a string of pipe or tubing 300 is built in the usual manner, except that transceiver sections 310 are added to the string at regular intervals. The string can be drill stem test (DST) tubing, drill pipe, a production string, or any other configuration generally used in a borehole. The transceiver sections are added about every 6000 feet of string, as this is the current outer limit on transmissions. Each transceiver section 310 contains a transceiver so that it can maintain two-way communications both up and down the string. It also contains a microprocessor for decision-making, batteries or another means of obtaining power, and sensors as appropriate for the particular job. In an alternate embodiment of the overall system, shown in FIG. 3B, the borehole splits near the bottom of the hole to form two lateral wells, with a multilateral junction head at the junction. Each lateral well can have its own sensors and transceiver(s), with a transceiver at the junction maintaining communications on different frequencies with each of the bottom transceivers.

The transceivers used in this communications are preferably configured to transmit and receive in the range of 300-5000 Hz. A simplified communication system is described below to illustrate the method. In the simplified system, binary data in the system is generally transmitted in one of two basic ways, either by a change in amplitude of the signal, or by a change in the frequency of the signal. When first establishing communications between the different transceivers along the drill string, commands are sent using a form of amplitude shift keying known as on-off keying (OOK), in which “0” and “1” are represented by the presence or absence of a signal. This initial transmission is based on numerical predictions of optimal channel properties. Each transceiver can both transmit and receive signals on a wide spectrum of frequencies. Once initial communications are established, the uphole transceiver section will then determine the number of channels on which an acceptable signal is received. This information, along with information about the channels used by the adjoining pairs to minimize cross-talk, is used to determine the method of communications.

When communicating using simple frequency shift Keying (FSK), preferably, at least two channels are required to be a useable pair. If so, one of these frequencies is assigned the value of “0”, while the other frequency receives the value of “1”. Communications can then take place by means of frequency shift keying (FSK), in which the transmitter shifts between the two chosen frequencies. However, since the transceiver section also contains a processor, the system is not limited to FSK on two channels. If, for example, four good frequencies are established, then two separate communication lines can be established between the pair of transceivers. If only one good frequency can be found, then the data can be transmitted by OOK on that single frequency. Additionally, once communications are set up, the microprocessor monitors the quality of the signal(s). If communications worsen, any section can recalibrate with its neighbors. Thus, this system has much greater flexibility to respond to changing conditions than previous systems.

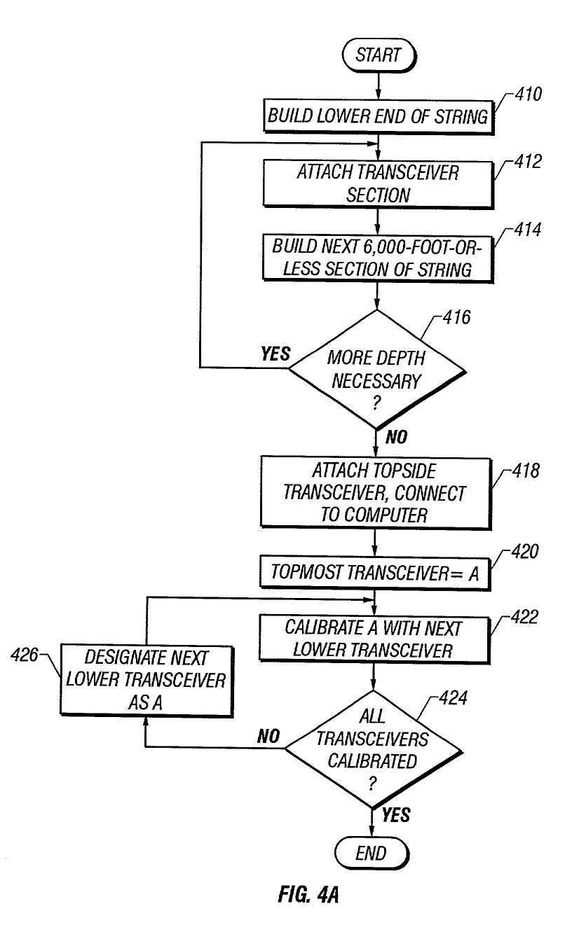

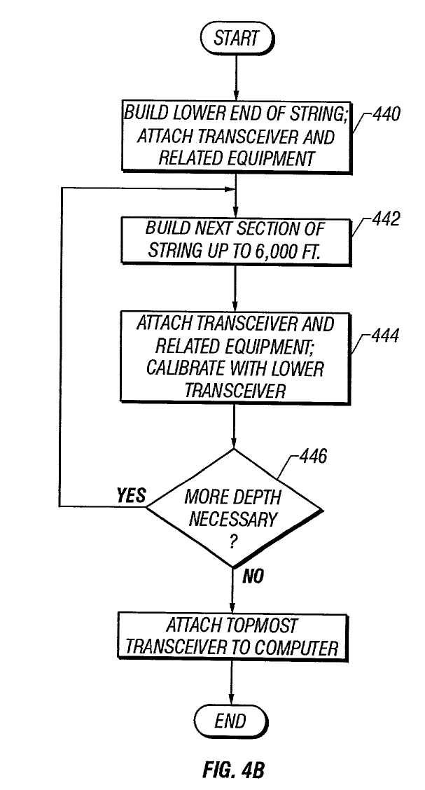

FIGS. 4A and 4B are two flowcharts, each showing building the string and calibrating the transceivers. FIG. 4A shows calibrating from the top transceiver down, which means that all transceivers will be in place before the calibration process starts. FIG. 4B shows calibrating from the lowest transceiver upward; calibration can start as soon as the first two transceivers are in place and proceed upward as new transceivers are added.

In FIG. 4A, the process starts with building the lower end of the string (step 410). If this is a drilling site, the lower end will include a drill bit and sections of pipe; in a production setting, the lower end can include a packer and a production string. The particular job determines the nature of this string. In any case, a transceiver section is attached near the bottom end of the string (step 412). New sections of pipe or tubing are then added (step 414). This section can be up to 6,000 feet in length, but can also be shorter if, for example, a production zone is reached. A determination is then made (step 416) whether or not the ultimate depth has been reached. If further depth is needed, the flow loops upward, where another transceiver section is attached (step 412) and further string built (step 414). Once sufficient string is built, the topmost transceiver is connected to the string and this transceiver section is connected to the computer (step 418). At this point, calibration can begin. The topmost transceiver is designated as “A” (step 420). Transceiver A calibrates with the next lower transceiver (step 422). After this pair has determined their pattern of communications, a check is made to see if there are lower transceivers needing calibration (step 424). If so, the designation as the “A” transceiver is passed to the transceiver just below the one currently designated (step 426) and transceiver section A is instructed to calibrate with the next lower transceiver (step 422). Once all transceiver pairs are calibrated, the algorithm ends.

In FIG. 4B, the flow appears much simpler, as the calibration of the pairs of transceivers can proceed even while the string is being built. The process begins with building the lower end of the string. Again, this can be any type tubing or pipe used with acoustic transceivers. The lowermost transceiver is attached (step 440). A section of string is then built, up to the maximum length of 6,000 (step 442). Another transceiver section is attached to the string, and at this point, the newly attached transceiver can begin calibrations with the transceiver just below it. It is understood that as the string grows longer, conditions between these two transceivers can change, so that the original calibration may no longer be optimal. However, the processor can determine that the conditions are worsening and can initiate a re-calibration. Additionally, the processor can be programmed to check calibrations periodically. In this manner, changes that allow more or better frequencies can be detected, and a shift made to a transmission mode that has a higher speed of transmission. While the transceiver sections are calibrating, a determination is made whether the string extends downward far enough (step 446). If not, the flow loops back, where new sections of string are built (step 442) and another transceiver attached and calibrated (step 444). Once the desired depth is reached, the topmost transceiver is connected to the computer (step 448).

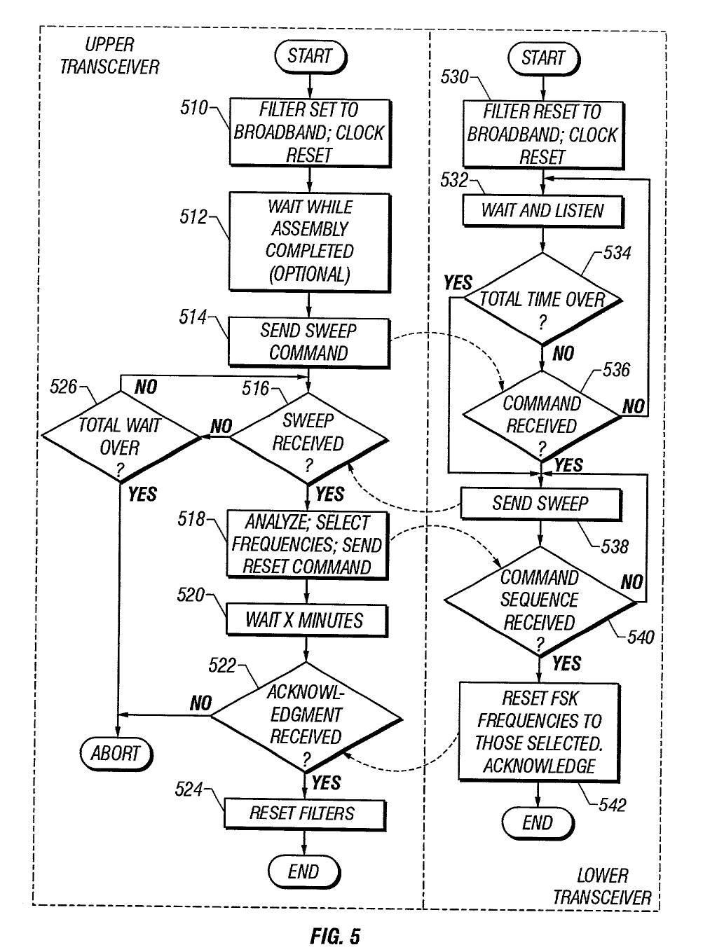

FIG. 5 shows a flowchart of the steps of calibrating an upper transceiver with a lower transceiver in accordance with a preferred embodiment of the disclosed invention. In a top-down scheme, the first iteration of this flowchart would be to calibrate the surface transceiver with the next lower transceiver, with subsequent iterations performed to calibrate each successively lower pair. For a bottom-upward scheme, the lowermost pair can begin calibration once both are activated. As each new transceiver is added, a new calibration can be started. FIG. 5 is divided into two sections, with the left-hand section showing the flow performed by the upper transceiver and the right-hand section showing the flow performed by the lower transceiver. Interactions between the two transceivers are shown by dotted lines.

To begin, filters on the upper transceiver are reset for broadband transmission and reception, while the clock is also reset (step 510). If there is further assembly to be done before the transceivers should begin calibration, the transceiver will be programmed to wait for a given period of time (step 512), to allow assembly of the acoustic telemetry system (ATS) to be completed. Once the waiting period is over, a command is sent (step 514) using OOK to instruct the lower transceiver to start sending a sweep of frequencies. This command is sent on a broadband communications channel that is identified a priori by the numerical models.

Meanwhile, receiver filters on the lower transceiver are set for broadband reception and its clock reset (step 530). Since the lower transceiver is placed in the borehole before the upper transceiver is attached, the lower transceiver will have time programmed for waiting (step 532), but during this time it will listen on the predicted frequency for the sweep command. When it is determined that either the waiting time is over (step 534) or the initial command has been received (step 536) the downhole transceiver will begin transmitting test signals to characterize the communications channel (step 538). The upper transceiver is meanwhile in the receiving mode and checks for the test signal (step 516). When the upper transceiver receives the test signals, it uses standard evaluation algorithms such as Fast Fourier Transforms (FFT) to identify and characterize the channels. Once the channels are identified, the upper transceiver notifies the lower transceiver, using the broadband OOK signal (step 518) and waits (step 520) to receive an acknowledgment (step 522). If a given time passes (step 526) without receipt of the test signal, or if no acknowledgment is received from the repeater, the automatic calibration process is aborted and other methods are resorted to calibrate the system.

For its part, the lower transceiver, after sending the sweep, listens for the command sequence (step 540) on the broadband channel. If a command is not received within a preset time, the lower transmitter continues to send sweeps every 1/n th of an hour, where n is a prime number. When it does receive the command sequence, the lower transceiver will reset the channel(s) and mode of communications to those selected and acknowledges receipt of the command to the surface transmitter (step 542). Filters on the lower transceiver are not, however, reset until the calibration with the transceiver below it is completed. Filters on the upper transceiver are reset at this time (step 524).

When this part of the calibration is completed, the process is repeated, with the downhole transceiver establishing communications with the transceiver below it in the same manner. The second pair or transceivers will establish communications on different frequencies than those used between the first pair. Since this is a top down algorithm, the further downhole a transceiver is, the longer a time it has in the borehole before communications are expected, so the longer a wait it expects.

Once the calibration identifies the best frequencies for a pair, the transmitter output can be optimized, as described below, to allow the best signal to noise ratio. Optimizing the transmitter output can conserve battery life, reduce incessant ringing in the tones and increase data transmission bandwidth.

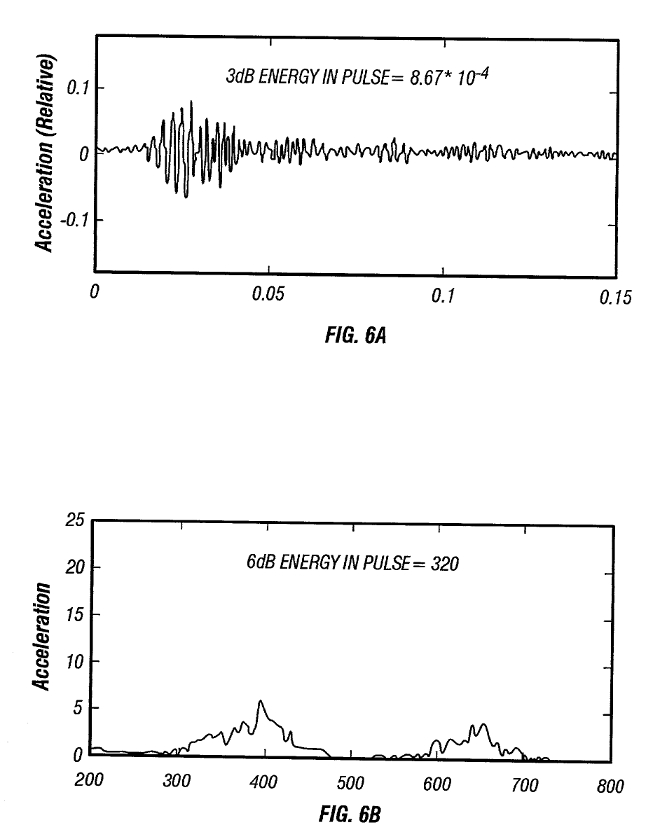

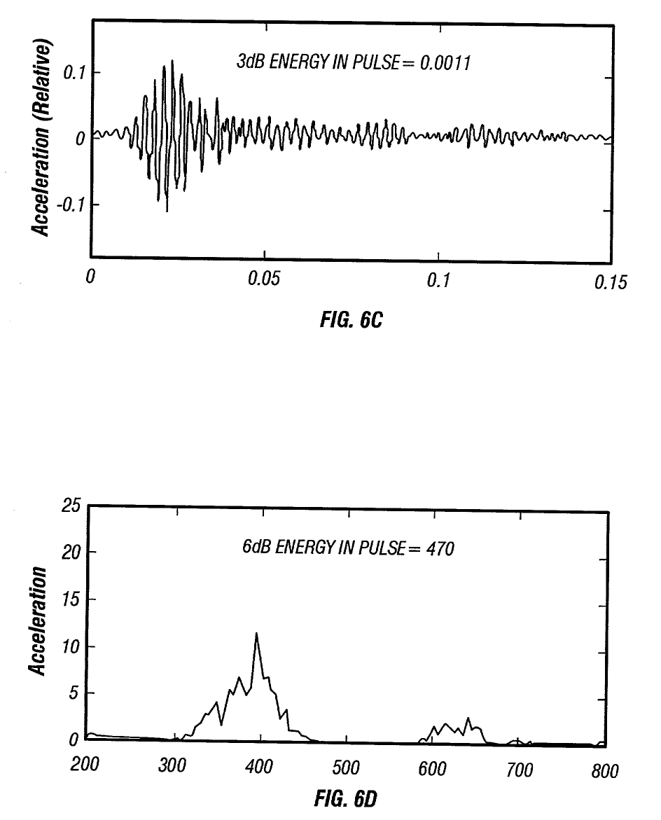

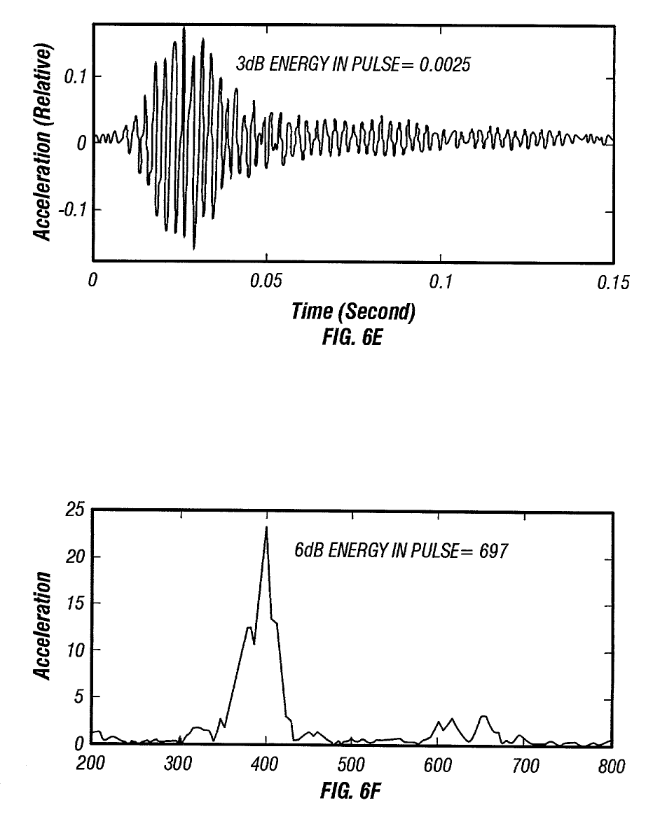

With reference to FIGS. 6A to 6F, experimental data from a test is shown, comparing the length of the toneburst (FIGS. 6A for 5 milliseconds, 6C for 10 milliseconds, and 6E for 20 milliseconds) at the transmitter with the respective signal received (FIGS. 6B, 6D, and 6F). As shown, increasing the number of cycles in the toneburst focuses the acoustic energy in the frequency, i.e., as the number of cycles increases from 2 to 8, the energy in the 350-450 Hz band increases nearly 2.8 times. This trend is expected to continue with additional cycles in the toneburst until the system reaches a stability condition at about 100 cycles.

In applications where intrinsic channel attenuation is high, increasing the number of cycles needed to signify a single bit can improve the quality of acoustic signals. There are two different methods of implementing the increase. The number of cycles can be increased by prolonging the “on” time of the toneburst, as shown in FIGS. 6A-F, although this increase in quality is associated with a penalty in terms of speed of sending data. In an alternative method, the highest frequency that can propagate through the tubing is chosen. This frequency will have the maximum number of cycles and thus the maximum energy. Thus, in attenuated channels, the transmitter can increase its output signal, without any significant change to its operating characteristics. On the other hand, in cases where the tubing is not very attenuated, the transmitter can reduce the number of cycles and conserve battery power or increase transmission rates.

As mentioned previously, once communications are established, changing conditions can affect the quality of communications on the preferred frequencies. As these changes happen, it is now possible to re-enter the calibration phase to reset communication parameters as necessary.

As can be seen, this innovative system provides numerous improvements over the previous system. The maximum depth to which communications can be maintained has increased dramatically, as well as allowing transmissions across multi-lateral junctions. Most importantly, the system is able to optimize itself without operator intervention, both at installation and during the life of the well operation.

We claim:

1. An acoustic telemetry system comprising communications along a plurality of transceivers attached to a string of tools in a borehole, wherein, after installation in the borehole, ones of said plurality of transceivers resolve communication parameters with ones of said plurality of transceivers.

2. The acoustic telemetry system according to claim 1, wherein said string of tools are from the group consisting of drill stem test tubing, coiled tubing, a drilling workstring, and a production string.

3. The acoustic telemetry system of claim 1, wherein said string of tools includes a multilateral junction head.

4. The acoustic telemetry system of claim 3, further comprising at least two separate lines of communications below said multilateral junction head.

5. An acoustic telemetry system comprising-directional communications along a plurality of transceivers attached to a string of tools in a borehole, wherein during normal operation of said transceivers, ones of said transceivers can initiate a calibration process in order to reconfigure communication parameters with another transceiver.

6. The acoustic telemetry system according to claim 5, wherein said string of tools are from the group consisting of drill stem test tubing, coiled tubing, a drilling workstring, and a production string.

7. The acoustic telemetry system of claim 5, wherein said string of tools includes a multilateral junction head.

8. The acoustic telemetry system of claim 7, further comprising at least two separate lines of communications below said multilateral junction head.

9. A method of acoustical communication, comprising the steps of:
attaching a plurality of transceivers at intervals along a string of tools in a borehole, said plurality of transceivers having respective associated processors;
negotiating communication parameters between a first transceiver and a second transceiver of said plurality of transceivers to obtain optimal communications between said first transceiver and said second transceiver;
communicating data and instructions between a surface processor and downhole equipment, which is attached to said string of tools, through said plurality of transceivers.

10. The method of acoustical communications of claim 9, wherein said string of tools are from the group consisting of drill stem test tubing, coiled tubing, a drilling workstring, and a production string.

11. The method of acoustical communications of claim 9, wherein said downhole equipment is a sensor.

12. The method of acoustical communications of claim 9, wherein said negotiating step uses on-off keying on a broadband.

13. The method of acoustical communications of claim 9, wherein said communicating step uses frequency shift keying on at least two frequencies.

14. A method of acoustical communications, comprising the steps of:
attaching a plurality of transceivers at intervals along a string of tools in a borehole, said plurality of transceivers having respective associated processors;
communicating data and instructions between a surface processor and downhole equipment, which is attached to said string of tools, through said plurality of transceivers;
during normal communications between a first transceiver and a second transceiver of said plurality of transceivers, re-initiating calibration instructions in order to optimize communications.

15. The method of acoustical communications of claim 14, wherein said string of tools are from the group consisting of drill stem test tubing, coiled tubing, a drilling workstring, and a production string.

16. The method of acoustical communications of claim 14, wherein said downhole equipment is a sensor.

17. The method of acoustical communications of claim 9, wherein said communicating step uses frequency shift keying on at least two frequencies.

18. A chip for an acoustic telemetry system comprising:
first circuitry that acoustically sends channel characterization signals;
second circuitry that receives said channel characterization signals and selects a plurality of channel properties for use in transmission;
third circuitry that acoustically transmits notification of said plurality of channel properties for use in transmission; and
fourth circuitry that receives data and acoustically transmits commands using said plurality of channel properties for transmission;
whereby said chip can establish acoustical communications with a similar chip.

19. The chip for an acoustic telemetry system of claim 18, wherein said plurality of channel properties comprises two frequencies and transmission by frequency shift keying.

20. The chip for an acoustic telemetry system of claim 18, wherein said plurality of channel properties comprises a frequency and transmission by on-off keying.

21. The chip for an acoustic telemetry system of claim 18, wherein said plurality of channel properties comprises an optimized number of cycles in a toneburst to obtain a balance between a clear signal, telemetry rates, and lifetime of a long term downhole power supply.

22. A structure associated with a borehole, said structure comprising:
a plurality of tools assembled in the borehole;
an acoustic telemetry system comprising communications along a plurality of transceivers attached to said string of tools in a borehole, wherein ones of said plurality of transceivers resolve communication parameters with other ones of said plurality of transceivers.

23. The structure of claim 23, wherein ones of said plurality of transceivers resolve communication parameters with other ones of said plurality of transceivers shortly after installation.

24. The structure of claim 23, wherein ones of said plurality of transceivers resolve communication parameters with other ones of said plurality of transceivers when communications deteriorate.

25. The structure of claim 23, wherein ones of said plurality of transceivers resolve communication parameters with other ones of said plurality of transceivers at regular periods during their lifetime.
